(19) United States
(12) Patent Application Publication
(10) Pub. No.: US 2007/0086635 A1
(43) Pub. Date: Apr. 19, 2007

(54) Method of identifying pattern in a series of data

(76) Inventors: Thomas Fink, London (GB); Sebastian Ahnert, Paris (FR); Francis Brown, Paris (FR); Karen Willbrand, Essen (DE)

Correspondence Address: YOUNG & THOMPSON, 745 SOUTH 23RD STREET, 2ND FLOOR, ARLINGTON, VA, 22202, US

(21) Appl. No.: 11/249,272

(22) Filed: Oct. 14, 2005

(51) Int. Cl. G06K 9/00

(52) U.S. Cl. 382/129

(57) ABSTRACT

A method of identifying pattern in a series of data, or curve, includes: first converting a curve to a permutation by relabelling the data points with their rank; second, segregating the set of all permutations into clusters of different sizes with respect to some map: permutations mapped to the same number are assigned to the same cluster. From this, one can write an alternative description of any curve, from which the original curve can be fully recovered. The length of this description is a bound on its AIC. The difference between this bound and the length of the original curve in bits, or Shannon information of the curve, is the number of bits k by which the curve can be compressed. The compression k is used to order a collection of curves in decreasing order of significance.

### TECHNICAL FIELD

The invention relates to a method of identifying pattern in a series of data. More particularly, the invention relates to Identifying non-random data series without knowing what kind of pattern they contain.

### BACKGROUND OF THE INVENTION

Identifying trends or pattern in a series of data is the traditional basis of hypothesis formation in the physical sciences. Typically, the pattern is incontrovertible and can be encapsulated by a concise mathematical relation between the data and the independent variable. However, many systems exhibiting collective behavior, such as genetic networks for example, exhibit weak pattern that is, the pattern does not look significantly different from a random series. Moreover, because the dynamics of collective systems are in general not understood (at most a statistical description is possible), it is not clear what kind of pattern to look for.

The present invention has one particularly advantageous, but not exclusive, application in the analysis of DNA microarray data. Microarray analysis permits scientists to detect thousands of genes in a small sample simultaneously and to analyze the expression of those genes.

Microarray technology allows the simultaneous measurement of thousands of gene concentrations. If one considers a series of microarray measurements, one obtains thousands of curves representing the changes in the concentration of each gene. In order to interpret this large amount of data, scientists make basic assumptions about the behaviour of genes. However, if these assumptions turn out to be incorrect, the underlying biological or medical processes could be completely overlooked, costing much time and effort.

### SUMMARY OF THE INVENTION

The purpose of the invention is to detect pattern in a data series, or curves, without making any assumptions about what kind of pattern to look for.

Another purpose of the present invention is to order data series according to their significance.

Another is to detect correlations (relatedness) between two curves and more generally, to construct a network of correlations between a large set of curves.

At least, one of the aforementioned purposes is achieved with a method of identifying pattern in a series of data. Said method comprises steps of:
considering M curves, each of which is made up of N distinct values,
converting each curve to a permutation π by relabelling said N values according to the rank of each of said N values,
considering a map γ from permutations to real numbers,
applying said map γ to each permutation of a curve, the combination of the map γ and the permutation π allowing an alternative description of each curve,
calculating, for each curve, the compression in bits k as the difference in bits between said alternative description and the length in bits, or Shannon information, of the curve, and
associating higher compression of a curve in bits k with the presence of more pattern in said curve, and identifying significant curves accordingly.

According to an embodiment of the present invention, the method further comprises steps of ordering said curves according to the compression in bits k, and identifying significant curves which have a compression value of k superior or equal to a predetermined threshold.

With the method of the present invention, a large number of data series can be approached without preconceptions of what sort of behaviour is significant. It can be used to study any data series in which the pattern is faint or clouded by noise, even when the number of data points is small. Furthermore, it provides a universal currency by which it is possible to compare the significance of data series of different lengths, from different experiments or exhibiting different forms of pattern.

The approach used in the present invention is to replace each data series with an alternative description from which the original data can be fully recovered. Data series with short descriptions, which are significantly compressible, are more, likely to result from simple underlying mechanisms than series which are incompressible. According to the invention, said alternative description constitutes a bound of the Algorithmic Information Content (AIC) or Kolmogorov complexity.

The AIC of a data series is the length in bits of the shortest possible algorithm, or description, of that data. The shorter the description of a curve, the more pattern it contains; conversely, a curve whose shortest description is as long as the data itself is said to be random. The AIC of a data series is, in general, fundamentally uncomputable, and at best it is possible to bound it from above. To do so, the method according to the present invention comprises steps of first converting a curve to a permutation by relabelling the data points with their rank when arranged in ascending order for example. Then segregating the permutations into clusters of different sizes with respect to some map: permutations mapped to the same number are assigned to the same cluster. From this, writing an alternative description of any curve, from which the original curve can be fully recovered. The length of this description is a bound on its AIC. The difference between this bound and the length of the original curve is the number of bits k by which the curve can be compressed. The compression k is used to order a collection of curves in decreasing order of significance. A curve with a high k is less likely to arise by chance and more likely to be the output of a simple underlying mechanism than curves with low k.

According to an advantageous characteristic of the invention, said compression in bits k is done by a relation based on:

$$k ( f \text{/} γ ) = {log}_{2} [ \frac{1}{P ( γ [ π ( f ) ] )} ] - {log}_{2} \vert Im ( γ ) \vert ,$$

where f represents a curve, |Im(γ)| is the size of the image of map γ, i.e., the number of values that the map γ can take, and P the probability that a random curve gives the same value as the value obtained when applying map γ on permutation π.

Preferably, the N values are measured with sufficient resolution such that no two values are the same.

The N distinct values might constitute measurements made over time or distance or any slowly changing parameter.

According to a no limitative embodiment of the invention, the data series are DNA microarray data series of genes. The N distinct values can constitute samples with respect to a variable such as time; dose of some additive, stimulant or drug; severity of disease or diagnosis or any slowly changing parameter.

Let a curve f be comprised of N distinct points f_{1,} f_{2 . . . ,} f_{N,} and let denote the corresponding permutation. According to the invention, the following maps gamma might be used, although this is in no way an exhaustive list:
γlong which is the length of the longest increasing or decreasing subsequence in π;
γopt which is the number of local optima in π;
γ+− which is the number of permutations with the same pattern of rises and falls in π;
γΔ₁ which is the sum of the absolute value of the first difference operator

$${Δ}_{1} = {\sum }_{i = 1}^{N - 1} \vert {f}_{i + 1} - {f}_{i} \vert ;$$
γΔ₂ which is the sum of the absolute value of the second difference operator

$${Δ}_{2} = {\sum }_{i = 1}^{N - 2} \vert {f}_{i + 2} - 2 {f}_{i + 1} + {f}_{1} \vert ;$$

and
γΔ₃ which is the sum of the absolute value of the third difference operator

$${Δ}_{3} = {\sum }_{i = 1}^{N - 3} \vert {f}_{i + 3} - 3 {f}_{i + 2} + 3 {f}_{i + 1} - {f}_{i} \vert .$$

Another embodiment of the invention is the determination of the similarity, or correlation, between two different curves. When this is done for all possible pairwise combination of curves, it allows one to create a matrix, or network, of curve-curve correlations. In the context of the no limitative embodiment of the invention described above, this permits one to determine which genes interact with each other or, in the language of genetic networks, which genes are nearby in network space.

Inferring pairwise relations amongst a set of many genes has been the subject of much interest amongst biologists and physicists alike. In previous techniques, each pair of genes is submitted to a similarity measure, where similarity is typically defined as a function of the N differences between corresponding points. The problem with this is that it is limited to expression curves which behave in similar ways: both genes increase linearly, or both suddenly turn off at some critical dose. What is rarely detected is the relation between two genes which are anticorrelated (if one increases the other decreases), or are related by some simple algebraic relation (one gene increases half as quickly as the other, or another gene rises or falls exponentially with the concentration of the other), or a differential relation (one gene decreases with the rate of change of the other, or one gene accumulates in proportion to another's concentration). Detecting these mathematical relations, which the invention allows, is important, because they dictate the bulk of chemical and physical interactions.

The correlation between two curves i and j can be established as follows: rearrange the points in both curves in exactly the same fashion, in such a way that the values of the N points in curve j are monotonically increasing. This determines the new ordering on the values of the N points in the curve i. For example if i is the curve 3,1,5,2,4, and j is 2,3,5,4,1, then after reordering, i is 4,3,1,2,5 and j is 1,2,3,4,5. Then compute the compression k of curve i as previously described. Repeat the process, swapping the curves i and j. The higher of these two compressions is a measure of the correlation between the two curves. When this is done for all pairs of curves i and j, the matrix of compressions obtained k(i,j) corresponds to the correlation (relatedness) between all pairs of curves

It will be understood that these, and other embodiments, can be practiced by combining steps from different embodiments. These and other embodiments of the invention will be better appreciated and understood when considered in conjunction with the following description and the accompanying drawings.

### BRIEF DESCRIPTION OF THE DRAWING FIGURES

FIG. 1 is a general view of the process of obtaining genomic data;

FIG. 2 Illustrates the application of the method of the present invention in order to obtain an addressing method, a list of ordered curves, and a weighted network of curves;

FIG. 3 is a clustering representation of the addressing method;

FIG. 4a shows 9 cell cycle expression curves in which 6 of them are clearly Identified as being significant;

FIG. 4b shows genes corresponding to curves of FIG. 4a with their rank according to some maps γ.

### DETAILED DESCRIPTION

Although the invention is not limited to it, one now will describe the method of the present invention applied to detecting microarray data series.

The widespread use of microarrays has made the measurement of genetic concentration levels mainstream. An important application is microarray expression series concerning any collection of microarrays which can be ordered to form a progression, as a function of time, or the onset of a disease, or any increasing dose of a stimulus.

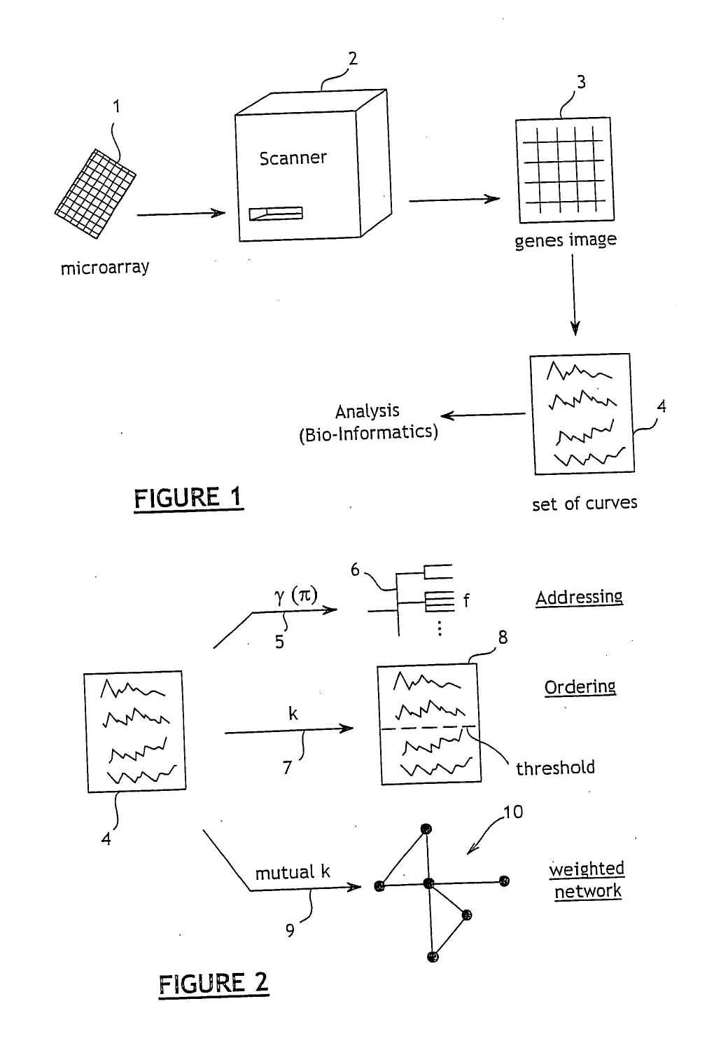

FIG. 1 is a general view of the principle of DNA microarrays. The microarray production process consists of spotting DNA fragments amplified by PCR technique on a microscopic glass slide. RNA are extracted from two cultures which provide a comparison of expression levels. Messenger RNA are then transformed into cDNA by reverse transcription. At this stage, DNA from the first culture has a green dye, whereas DNA from the second culture is labelled with a red dye. At the stage of hybridisation, green labelled cDNA and red labelled cDNA are mixed together and put on the matrix of spotted single strand DNA. Such a microarray is represented on FIG. 1 as element 1. The microarray 1 is then fed to a laser scanner 2 via an aperture 2a. Laser scanner 2 can be a confocal microarray scanning system capable of generating an image 3 by detection of fluorescence.

The ability to measure thousands of gene expression levels in parallel using microarrays has provided scientists with a complex, unique fingerprint of a cell or tissue sample. Understanding how this fingerprint changes during physiological processes is one of the most pressing problems in bioinformatics. In order to analyse the image 3, the evolution of each DNA fragment is represented as a curve on the image 4. The method of the present invention is advantageously applied to this set of curves 4 in order determine an addressing method 6 by using a map gamma and permutations π as denoted on FIG. 2. The present invention also permits one to generate a list 8 of curves ordered according to a compression in bits k 7. A threshold can be applied to the list in order to identify curves containing useful information. It is also possible to calculate mutual compression in bits k 9 in order to identify correlation between curves and generate a weighted network 10 of genes.

Practically, the method of the present invention will now be explained by considering one curve f composed of N data points, each taken from the interval (0,1] with resolution T, that is, there are T possibilities for each point. T is large enough such that no two points i and j are the same. For N=5 and T=100, f might be, for example, 0.77,0.84,0.51,0.30,0.26.

To store an arbitrary curve f on a computer, the size of the file in bits, or Shannon information, is

$$H ( f ) = - {\sum }_{f} {T}^{- N} {log}_{2} {T}^{- N} = {log}_{2} {T}^{N} \qquad ( equation 1 )$$

Instead of storing the curve directly, it is possible to write down instructions for generating it, and store this instead. If the size of this file in bits is less than the Shannon information, then the curve is compressible by their difference in size.

π(f) is the permutation of the curve f; this is the permutation formed by replacing each data point with its rank when ordered from lowest to highest: π(f)=(4,5,3,2,1), which is one of the 5!=120 circles illustrated in FIG. 3. There are many curves with the same permutation π. In the limit of T>>N² there are T^{N}/N! of them. Each set of curves with the same permutation π is a circle in FIG. 3. γ is a map from permutations to real numbers. Permutations π with the same number γ(π) are grouped together, and the resulting set of curves is called S_{γ(π)}. Each group of permutations is one of the clusters γ(π) in FIG. 3. Note that in FIG. 3 all the circles are the same size but the size of the clusters can vary.

The curve f is encoded in two parts: the coarse address of the cluster S_{γ(π)} and the fine address of the curve f inside the cluster S_{γ(π)}. The number of bits necessary to store the address of S_{γ(π)} is log₂ of the total number of sets. The number of sets is simply the size of the image of the map γ (the number of values it can take), which is denoted |Im(γ)|. The number of bits necessary to store the address of f inside S_{γ(π)} is log₂ of the number of curves in S_{γ(π)}. Now the probability that a random curve f takes on the value γ(π(f)) is the number of curves in S_{γ(π(f))} divided by the total number of curves, that is, P(γ(π(f)))=|S_{γ(π(f))}|/T^{N}. Therefore to specify f within S_{γ(π(f))} requires log₂ [T^{N}P(γ(π(f)))] bits. The bound on the AIC of f is the sum of log₂ of both addresses, that is,
I^{bnd}(f|γ)=log₂ [T^{N}P(γ(π(f)))]+log₂|Im(γ)| (equation 2)

This means that from a string of length I^{bnd}(f|γ) bits, it is always possible to reconstruct the original curve f.

The total compression k(f|γ)=H(f)−I^{bnd}(f|γ), which by (equation 1) and (equation 2) is
k(f|γ)=log₂ [1/P(γ(π(f)))]−log₂|Im(γ)| (equation 3)

The curve is compressible by at least k bits. This can be expressed in a different form by noting that <|S_{γ(π)}|>=T^{N}/|Im(γ)|

,where <|S_{γ(π)}|> is the average value of the size of the set S. Substituting this into (equation 3) yields:

$$. k ( f \text{/} γ ) = {log}_{2} \frac{〈 \vert {S}_{γ ( π )} \vert 〉}{\vert {S}_{γ ( π ( f ) )} \vert} \qquad ( equation 4 )$$

Only when the size of S is less than its mean is k positive and the curve f compressible. Thus an effective map preferably partitions the space of permutations in such a way that the clusters are of a wide variety of different sizes.

It now remains to choose the map γ from permutations to numbers. Some of the simplest maps are:
γlong which is the length of the longest increasing or decreasing subsequence;
γopt which is the number of local optima;
γ+− which is the number of permutations with the same pattern of rises and falls;
γΔ₁ which is the sum of the absolute value of the first difference operator

$${Δ}_{1} = {\sum }_{i = 1}^{N - 1} \vert {f}_{i + 1} - {f}_{i} \vert ( used in figure 3 ) ;$$
γΔ₂ which is the sum of the absolute value of the second difference operator

$${Δ}_{2} = {\sum }_{i = 1}^{N - 2} \vert {f}_{i + 2} - 2 {f}_{i + 1} + {f}_{1} \vert ;$$

and
γΔ₃ which is the sum of the absolute value of the third difference operator

$${Δ}_{3} = {\sum }_{i = 1}^{N - 3} \vert {f}_{i + 3} - 3 {f}_{i + 2} + 3 {f}_{i + 1} - {f}_{i} \vert .$$

Other maps can easily be imagined. A defining characteristic of all the above maps is that their descriptions are short compared to an arbitrary assignment of the N! permutations to numbers.

One can also define a class of maps y by considering at any one time the permutation of a local short segment of a curve in the following way. Suppose the curve comprises N points f1, . . . , fN. Fix the size of a local window m. Then the curve segments fi, . . . , fi+m for i=1, . . . ,N−m defines a short permutation, to which can be applied a map γ′. The map γ is then defined to be the sum of the values γ′ over all N−m short segments. For example, let m=2. Each local window of a curve gives a permutation of length 2, that is, (1,2) or (2,1). If γ′ assigns the value 1 to the permutation (1,2) and 0 to (2,1) then the resulting map γ obtained by summing γ′ over all local segments of length 2 is just the number of rises in a curve. As a second example, let m=3. Each local window is a permutation of length 3, of which there are 6. Let γ′ be the map which gives the value 1 to the two permutations (1,3,2) and (2,1,3) and 0 to all others. Then the resulting map γ is just γopt, the number of local optima, defined above.

Practically, according to FIG. 3, the map γ is the sum of the absolute values of the differences of consecutive points (the first difference operator, Δ₁), then γ(4,5,3,2,1)=1+2+1+1=5. The probability that a random curve gives the same value is P(5)=4/120, since 4 of the 120 balls lie in the γ(π)=5 cluster above. The size of the image of y, or the total number of clusters, |Im(γ)|=8. Then, k(f|γ)=log₂ [1/P(γ(π))]−log₂ |Im(γ)|=1.92, which is the number of bits by which f is compressed by using Δ₁. The sizes of the 8 clusters for γΔ₁ above are 2,4,8,14,14,18,28,32; for comparison, γ+− gives 1,1,4,4,4,4,6,6,9,9,9,9,11,11,16,16.

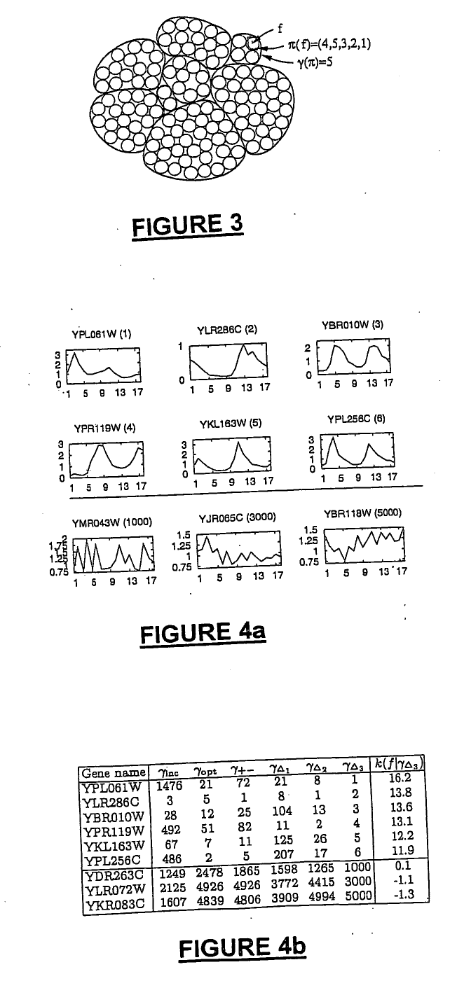

The present method was applied to yeast cell cycle time series of Spellman, comprising 6073 curves of 18 points sampled over 2 cell cycles and synchronised by α-factor. The top 6 genes ranked by γΔ₃ and their expression curves are shown in FIG. 4a and curves at positions 1000, 3000 and 5000 when ranked by k(f|γΔ₃). The same genes and their rank according to other maps γ are showed in FIG. 4b, the last column being the compression in bits k(f|γΔ₃).

The present method permits the identification of physically meaningful data series and is fundamentally different to other approaches (i) it is an unbiased, rigorous detector of pattern; (ii) it provides a universal currency for comparing, curves from different experiments; (iii) its implementation is independent of details of the experiment or system; and (iv) it is applicable even when the number of data points is small.

First, the method allows quantifying the presence of pattern, regardless of what kind of pattern it is. Selecting data series by their compression in bits k is not explicitly biased towards any anticipated behaviour. Because there are no free parameters which need to be adjusted or depend on the experiment (or system) in question, interpretation of the results is straightforward.

Second, the compression in bits k is a universal currency by which curves can be ranked according to their significance, even If they are of different lengths (numbers of data points), or exhibit different kinds of pattern, or are the output of different experiments. This is done by considering absolute reduction in bits, rather than relative reduction, because the presence of pattern is piecewise independent.

Third, although the described example concerns yeast cell cycle data, the implementation would be no different for a system about which nothing is known. Because the map γ is not applied to a curve f itself but to its permutation π(f), the distribution of γ(π(f)) does not depend on the distribution of the individual points which make up the curve; Gaussian distributed data are just as likely to generate some value of γ(π) as uniformly distributed data. This puts the background noise on a level playing field, enabling the ordering of curves by the pattern expressed. Moreover, one-to-one transformations of a curve (such as the logarithm) do not change the value of γ(π(f)). This is important because (often unknown) transformations are implicit in measuring and processing the data.

Fourth, because the present method is not computing statistical averages over data points but rather an entire curve's exact compression, it is not necessary to have many data points N to make definite conclusions. The number N depends only on the number of curves M under consideration; preferably N! should be greater than M. In the case of yeast cell cycle above, M=6073 which gives N>7.

The method of the present invention provides a general, rigorous and unbiased framework for detecting non-random data series in any system which exhibits random or near random fluctuations. Because a collection of microarrays can be ordered by any observable, data need not be in the form of time series; in a study of breast tumours, samples were ordered by stage and grade, tumour size and time to death. Instead, if the array are ordered by a particular gene's expression level, gene-gene correlations can be identified. By repeating this over all genes one could build a genetic network in which each bond corresponds to the mutual information between gene pairs (see network 10 in FIG. 2). This provides a much more sensitive test of gene-gene interaction than elementary measures of similarity based on point-wise differences.

Although the various aspects of the invention have been described with respect to preferred embodiments, it will be understood that the invention is entitled to full protection within the full scope of the appended claims.

1. A method of Identifying pattern in a series of data, comprising steps of:
considering M curves, each of which is made of N distinct values,
converting each curve to a permutation π by relabelling said N values according to the rank of each of said N values,
considering a map γ from permutations to real numbers,
applying said map γ to each permutation of a curve, the combination of the map γ and the permutation n allowing an alternative description of each curve,
calculating, for each curve, the compression in bits k as the difference in bits between said alternative description and the length of the curve in bits, or the Shannon information of the curve, and
associating higher compression of a curve in bits k with the presence of more pattern in said curve, and identifying significant curves accordingly.

2. Method according to claim 1, wherein said alternative description constitutes the bound of the Algorithmic Information Content of the curve.

3. Method according to claim 1, wherein the step of applying said map γ on each permutation of curve comprises segregating permutations into clusters of different sizes, permutations mapped to the same number being assigned to the same cluster.

4. Method according to claim 1, wherein said compression in bits k is done by a relation based on:
$$k ( f / γ ) = {log}_{2} [ \frac{1}{P ( γ [ π ( f ) ] )} ] - {log}_{2} \vert Im ( γ ) \vert ,$$
where f represents a curve, |Im(γ)| is the number of values that the map γ can take, and P is the probability that a random curve gives the same value as the value obtained when applying the map γ on permutation π.

5. Method according to claim 1, wherein the N distinct values in the data series constitute samples over a time variable.

6. Method according to claim 1, wherein the N distinct values in the data series constitute samples of a price, or value of a stock or share, or exchange rate in financial markets.

7. Method according to claim 6, wherein the N distinct values in the data series constitute the changes between consecutive samples of a price, or value of a stock or share, or exchange rate in financial markets.

8. Method according to claim 1, wherein the N distinct values in the data series are DNA microarray expression values from an ordered series of N distinct microarrays.

9. Method according to claim 8, wherein the N distinct microarrays are ordered by time.

10. Method according to claim 8, wherein the N distinct microarrays are ordered by the dose of some additive or drug.

11. Method according to claim 8, wherein the N distinct microarrays are ordered by severity of disease or diagnosis.

12. Method according to claim 1, wherein the step of relabelling N values is made by arranging said N values according to an ascending or descending order.

13. Method according to claim 1, wherein the map γ is a function obtained by summing the values of another map γ′ over the permutations defined by all short local segments of a curve of a fixed length.

14. Method according to claim 1, wherein map γ is γlong which is the length of the longest increasing or decreasing subsequence.

15. Method according to claim 1, wherein map γ is γopt which is the number of local optima.

16. Method according to claim 1, wherein map γ is γ+− which is the number of permutations with the same pattern of rises and falls.

17. Method according to claim 1, wherein map γ is γΔ₁ which is the sum of the absolute value of the first difference operator
$${Δ}_{1} = {\sum }_{i = 1}^{N - 1} \vert {f}_{i + 1} - {f}_{i} \vert .$$

18. Method according to claim 1, wherein map γ is γΔ₂ which is the sum of the absolute value of the second difference operator
$${Δ}_{2} = {\sum }_{i = 1}^{N - 2} \vert {f}_{i + 2} - 2 {f}_{i + 1} + {f}_{i} \vert .$$

19. Method according to claim 1, wherein map γ is γΔ₃ which is the sum of the absolute value of the third difference operator
$${Δ}_{3} = {\sum }_{i = 1}^{N - 3} \vert {f}_{i + 3} - 3 {f}_{i + 1} + 3 {f}_{i + 1} - {f}_{i} \vert .$$

20. Method according to claim 1, further ordering said curves according to the compression in bits k, and Identifying significant curves which have a compression value of k superior to a predetermined threshold.

21. Method according to claim 1, wherein the values are ordered such that the 1^{st} curve is monotonically increasing, then reordered such that the 2^{nd} is monotonically increasing, and then the 3^{rd}, and so on; and wherein the compression of the ith curve ordered by the jth curve or the jth curve ordered by the ith curve, whichever is the highest, is recorded as kij.

22. Method according to claim 21, wherein the kij are used to order the strengths of interactions between pairs of curves i and j.

23. Method according to claim 21, wherein the kij are used to generate a fully connected weighted network of curve-curve correlations.

24. Method according to claim 23, wherein the fully connected network of weighted interactions is used to derive clusters of correlated curves by way of deleting all connections below a predetermined threshold.
